(19) United States
(12) Patent Application Publication
(10) Pub. No.: US 2013/0211643 A1
(43) Pub. Date: Aug. 15, 2013

(54) ENGINE FUEL ECONOMY UNIT

(71) Applicants: Alan Robert Cox, Risinghurst (GB); Gordon Moir Anderson, Bicester (GB)

(72) Inventors: Alan Robert Cox, Risinghurst (GB); Gordon Moir Anderson, Bicester (GB)

(73) Assignee: ZETA AUTOMOTIVE LIMITED, Bicester (GB)

(21) Appl. No.: 13/702,739

(22) PCT Filed: Jun. 8, 2011
(86) PCT No.: PCT/GB11/51073

§ 371 Date: Jan. 30, 2013

(30) Foreign Application Priority Data
Jun. 8, 2010 (GB) 1009574.3

(51) Int. Cl. F02D 35/00; B60L 15/20

(52) U.S. Cl. CPC F02D 35/00; B60L 15/2045
USPC 701/22; 701/110

(57) ABSTRACT

A fuel economy unit (30) is disclosed for an engine system comprising an internal combustion engine or electric motor having a demand input, an output member drivable by the engine, and a user-operable demand control (13) for providing a demand signal (P1,P2) coupled to the engine demand input to control the engine output. The fuel economy unit receives an input signal (D) indicative of acceleration of the output member, or from which acceleration of the output member can be derived, and modifies the coupling of the demand signal to the engine demand input in dependence on the acceleration of the output member to limit the acceleration of the output member.

This invention relates to a unit for improving fuel economy of an engine. The invention was initially conceived for use with internal combustion engines powering motor vehicles. However, it may also be used with electric motors, especially but not exclusively if battery powered, and the invention is not restricted to being for use with vehicles. In the context of this specification, the term ‘engine’ is intended to encompass not only internal combustion engines but also electric motors, and the term ‘fuel’ is intended to encompass not only fuel substances but also electricity.

The fuel economy of a vehicle powered by an IC engine depends on a number of factors. Some of these factors cannot be varied to any great extent by the vehicle user but others can. For example, fuel economy decreases: if the vehicle is driven at excessively high speed; if too low a gear is selected for a particular road speed so that the engine speed is excessively high; if the demand on the engine is suddenly increased by flooring the accelerator pedal, in particular with a petrol engine with acceleration enrichment; if in particular a goods vehicle is driven at or near its limit of performance when lightly laden; and if an engine is allowed to idle when the vehicle is stationary.

An aim of the present invention, or at least of specific embodiments of it, is to provide a device which can result in fuel economy being improved.

In accordance with a first aspect of the invention, there is provided a fuel economy unit for an engine system comprising an engine having a demand input (such as an accelerator pedal position input of an ECU of the engine), an output member (such as a drive shaft or wheel hub) drivable by the engine, and a user-operable demand control (such as an accelerator pedal) for providing a demand signal coupled (for example by a cable or bus) to the engine demand input to control the engine output. The fuel economy unit of the first aspect of the invention comprises: means for receiving an input signal indicative of acceleration of the output member or from which acceleration of the output member can be derived; and means for modifying the coupling of the demand signal to the engine demand input in dependence upon the acceleration of the output member to limit the acceleration of the output member. Put another way, when the operation of the demand control would result in harsh acceleration, the fuel economy unit can fool the engine into thinking that less demand is being placed on it. Accordingly, the fuel economy of the engine can be expected to increase in such circumstances.

The modifying means is preferably operable to modify the demand signal to represent a lesser demand when the acceleration of the output member reaches an acceleration threshold value. In order to provide a smooth response of an engine fitted with the fuel economy unit, the modifying means is more preferably operable to modify the demand signal to represent a progressively reducing demand while the acceleration of the output member exceeds an acceleration threshold value.

The acceleration threshold value may be preset. However, when used in circumstances where the load on the engine increases considerably with increasing speed of the engine or of the output member (as in the case of a vehicle engine overcoming air drag), this may result in more than desirable limiting of acceleration at low speeds and/or less than desirable limiting of acceleration at high speeds.

Therefore, the input receiving means, or a further input receiving means, is preferably arranged to receive an input signal indicative of the speed of the output member or from which speed of the output member can be derived. In this case, the acceleration threshold value is preferably dependent on the speed of the output member. For example, the lower the output member speed, the higher the permitted acceleration of the output member.

The fuel economy unit may further include means for deriving the acceleration of the output member by differentiation with respect to time of the speed of the output member. Therefore, having received a signal indicative of speed of the output member, or having derived a speed signal from some other input signal (such as a position signal), the fuel economy unit does not need to receive any further input signals in order to determine the acceleration of the output member.

The modifying means is preferably also operable to modify the coupling of the demand signal to the engine demand input in dependence upon the speed of the output member to limit the speed of the output member. For example, the modifying means is preferably operable to modify the demand signal to represent a lesser demand when the speed of the output member reaches an output speed threshold value. In the case of a vehicle, this feature can therefore be used to limit the vehicle's road speed.

In the case where, for example, the fuel economy unit is for use with an engine system also having a variable-ratio gearbox between the engine and the output member (e.g. a manual or automatic discrete ratio or continuously variable gearbox), the fuel economy unit preferably further includes further means for receiving a further input signal indicative of the speed of the engine or from which the speed of the engine can be derived. The acceleration threshold value may then be made dependent on the speed of the engine, for example with the modifying means limiting the acceleration of the output member when the acceleration of the output member reaches a value dependent on the speed of the engine.

The modifying means may also be operable to modify the demand signal to represent a lesser demand when the speed of the engine reaches an engine speed threshold value. In order again to provide a smooth response of an engine fitted with the fuel economy unit, the modifying means is more preferably operable to modify the demand signal to represent a progressively reducing demand while the speed of the engine exceeds an engine speed threshold value.

In accordance with a second aspect of the invention, the invention also extends to an engine system comprising: an engine (such as an internal combustion engine, an electric motor, or a hybrid of the two) having a demand input; an output member drivable by the engine; a user-operable demand control for providing a demand signal coupled to the engine demand input to control the engine output a user-operable demand control; and a fuel economy unit according to the first aspect of the invention for modifying the coupling between the demand signal to the engine demand input.

In the case where the engine includes an electronic ECU having an electrical demand input acting as the engine demand input and where the user-operable demand control comprises a demand sensor for producing an electrical demand signal dependent on the position of the demand control and a connection for connecting the demand signal to a demand input of the ECU, the modifying means is preferably operable to modify the demand signal between the demand sensor and the demand input of the ECU.

In the case where the engine system includes a first sensor for producing an electrical signal indicative of acceleration of the output member or from which acceleration of the output member can be derived, it is preferably that electrical signal which is received by the signal receiving means of the fuel economy unit.

Particularly in the case where the engine system includes a variable-ratio gearbox between the engine and the output member and a second sensor for producing a further electrical signal indicative the speed of the engine or from which the speed of the engine can be derived, it is preferably that further electrical signal which is received by the further signal receiving means of the fuel economy unit.

In accordance with a fourth aspect of the invention, the invention also extends to a motor vehicle having an engine system according to the third aspect of the invention. In this case, the output member preferably has a speed which is substantially proportional to the road speed of the vehicle. For example, the output member may be a gearbox output shaft or a road wheel or its hub.

Specific embodiments of the present invention will now be described, purely by way of example, with reference to the accompanying drawings, in which:

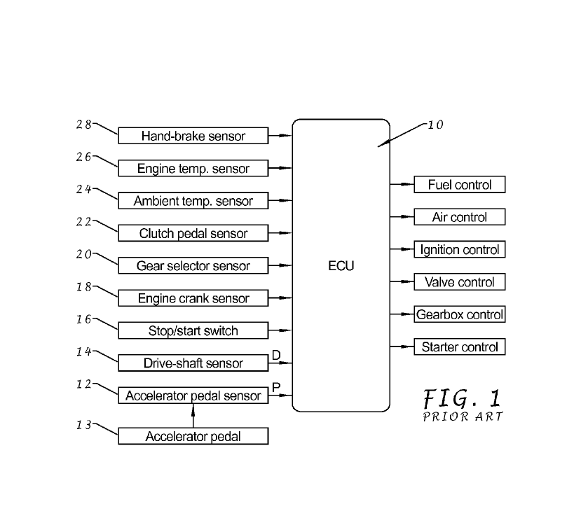

FIG. 1 is a schematic block diagram of a conventional vehicle engine management system;

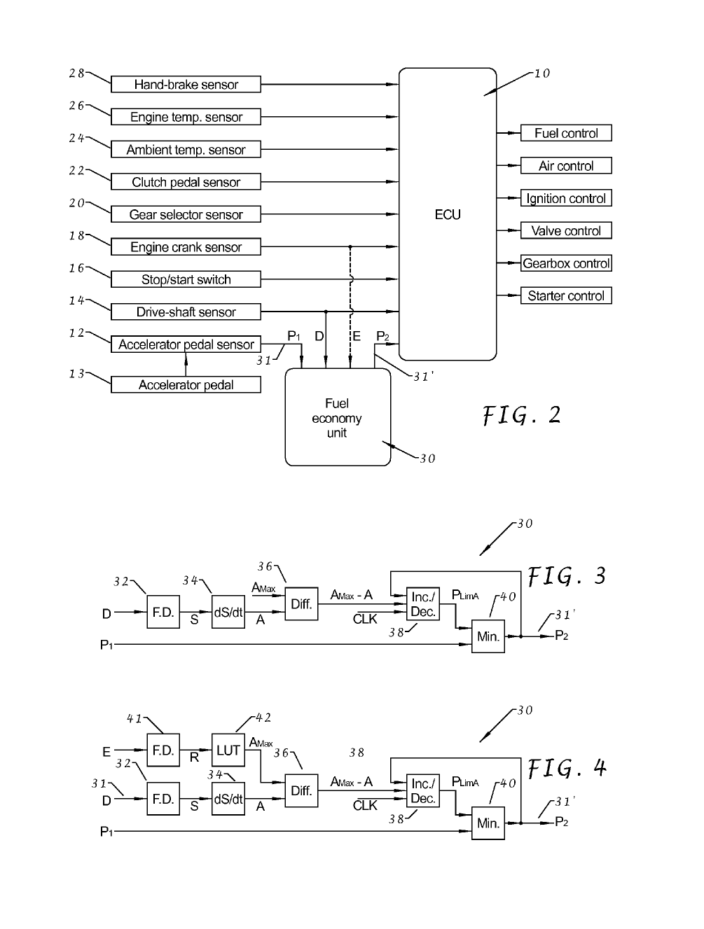

FIG. 2 is similar to FIG. 1, but showing the addition of a fuel economy unit of a first embodiment of the invention;

FIG. 3 is a schematic diagram illustrating one form of functioning of the fuel economy unit of FIG. 2;

FIG. 4 is a schematic diagram illustrating one form of functioning of the fuel economy unit of FIG. 2;

FIG. 5 is similar to FIG. 2, but showing a fuel economy unit of a second embodiment of the invention; and

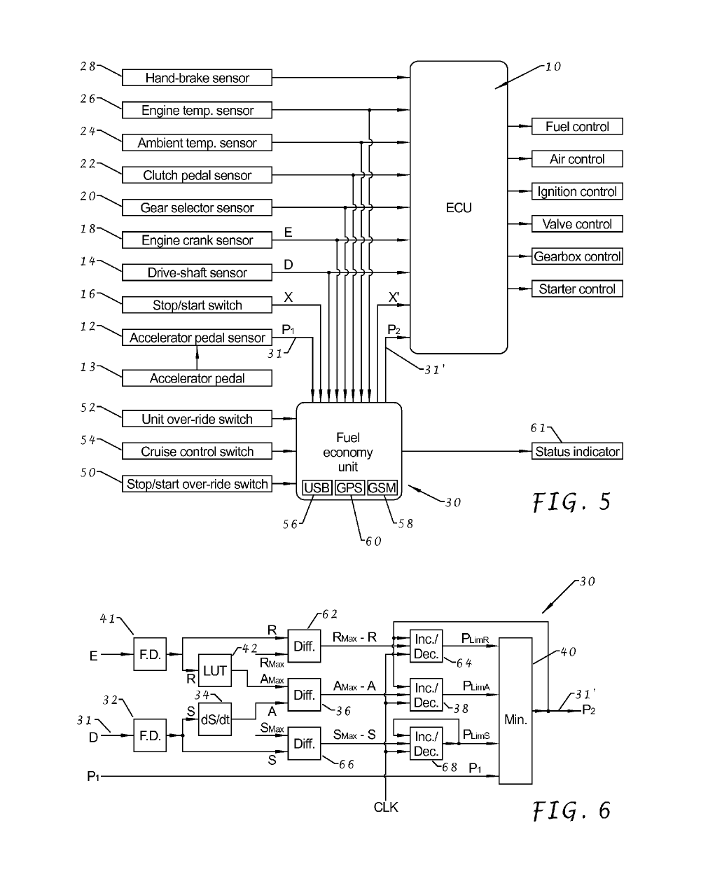

FIG. 6 is a schematic diagram illustrating functioning of the fuel economy unit of FIG. 5.

Referring to FIG. 1, in a conventional engine vehicle management system, an engine control unit (ECU) 10 receives input signals from a number of sensors and switches, such as a sensor 12 for an accelerator pedal 13, a vehicle drive-shaft position sensor 14, a start-stop switch 16, and engine crankshaft position sensor 18, a gear selector sensor 20, a clutch pedal sensor 22 (if the vehicle has a manual gearbox), an ambient temperature sensor 24, an engine temperature sensor 26 and a hand-brake sensor 28. The ECU 10 processes the input signals to produce a number of output signals for controlling various engine functions, such as the fuel and air supply rates, the ignition timing, the valve timing, the gear selected by the engine's gearbox and the operation of the engine's starter motor. The ECU 10 may be implemented as a single unit, or a number of separate units. The input and output signals may be supplied to and from the ECU 10 by individual conductors or by a bus, such as a CAN-bus. The various signals may be analogue, digital or pulsed. Included amongst the input signals are the accelerator pedal signal P representing the position to which the driver of the vehicle has depressed the accelerator pedal 13 and the vehicle drive-shaft position signal D which may for example take the form of a pulse train with one or more pulses for each turn of a drive shaft of the vehicle, in which case the frequency of the pulse train is proportional to the road speed of the vehicle.

Referring now to FIG. 2, the fuel economy unit 30 of the first embodiment of the invention receives the drive-shaft position signal D. The fuel economy unit 30 is also disposed in series with the signal connection 31,31′ from the accelerator pedal sensor 12 to the ECU 10, so that the fuel economy unit 30 receives as an input the accelerator pedal signal P₁ from the accelerator pedal sensor 12 and provides to the ECU 10 an output accelerator pedal signal P₂ which may differ from the input accelerator pedal signal P₁ in dependence upon the drive-shaft position signal D.

Referring to FIG. 3, in one form of functioning of the fuel economy unit 30, the unit 30 performs a frequency detecting function 32 which detects the frequency of the drive-shaft position signal D to produce a signal S representing the road speed of the vehicle. The unit 30 also performs a differentiating function 34 which differentiates the speed signal S with respect to time to produce an acceleration signal A representing the road acceleration of the vehicle. The unit 30 also performs a differencing function 36 which subtracts the acceleration signal A from a preset constant A_{Max} representing the maximum allowable road acceleration of the vehicle to produce a difference signal A_{Max}−A representing the amount by which the road acceleration is less than the maximum allowable acceleration. With each of a series of clock pulses CLK having a frequency F, the unit 30 also performs an incrementing/decrementing function 38, depending on the sign of the difference signal A_{Max}−A, on the output accelerator pedal signal P₂ to produce a pedal limit signal P_{LimA}. In particular, if the difference signal A_{Max}−A is positive, then the incrementing/ decrementing function 38 adds a predetermined amount dP to the output accelerator pedal signal P₂ to produce the pedal limit signal P_{LimA}. On the other hand, if the difference signal A_{Max}−A is negative, then the incrementing/decrementing function 38 subtracts the predetermined amount dP from the output accelerator pedal signal P₂ to produce the pedal limit signal P_{LimA}. The predetermined amount dP may, for example, be 2% of the maximum input accelerator pedal signal. The frequency F of the clock signal CLK may, for example, be 10 Hz. The unit 30 furthermore performs a minimising function 40 on the input accelerator pedal signal P₁ and the pedal limit signal P_{LimA} to produce the output accelerator pedal signal P₂, which is the lesser of P₁ and P_{LimA}.

It will therefore be appreciated that:
the output accelerator pedal signal P₂ will never exceed the input accelerator pedal signal P₁;
if the calculated road acceleration A exceeds the predetermined maximum road acceleration A_{Max}, the output accelerator pedal signal P₂ will be ramped down at a rate of dP×F (for example 20% per second); and
if and while the input accelerator pedal signal P₁ exceeds the output accelerator pedal signal P₂ and the calculated road acceleration A is less than the predetermined maximum road acceleration A_{Max}, the output accelerator pedal signal P₂ will ramp up at a rate of dP×F (for example 20% per second).

It will be noted that with the form of functioning described with reference to FIG. 3, the maximum allowable acceleration is a preset constant A_{Max}. However, it is desirable that the maximum allowable acceleration progressively decreases the higher the engine speed or the higher the road speed. In order to provide this additional functionality, with the maximum allowable acceleration being dependent on engine speed, another form of functioning of the fuel economy unit will now be described with reference to FIGS. 2 and 4. The unit 30 of FIG. 4 additionally receives as an input the engine crank position signal E, as shown by the dashed line in FIG. 2. The unit 30 includes a further frequency detecting function 41 which detects the frequency of the engine crank position signal E to produce a signal R representing the engine speed of the vehicle. The engine speed signal R is supplied to a look-up function 42 which is programmed to produce the maximum allowable acceleration signal A_{Max} in dependence upon the engine speed signal R. At low engine speeds, the maximum allowable acceleration signal is relatively high, but decreases progressively with increasing engine speed. Rather than employing a look-up function 42, a mathematical function may be employed, for example an inverse function or an inverse square function.

Referring now to FIGS. 5 and 6, the fuel economy unit 30 of the second embodiment of the invention provides additional functionality compared with the unit 30 described above with reference to FIGS. 2 and 4.

The unit 30 of FIG. 6 also performs a differencing function 62 which subtracts the engine speed signal R from a preset constant R_{Max} representing the maximum allowable engine speed to produce a difference signal R_{Max}−R representing the amount by which the engine speed is less than the maximum allowable engine speed. With each of the series of clock pulses CLK, the unit 30 also performs an incrementing/decrementing function 64, depending on the sign of the difference signal R_{Max}−R, on the output accelerator pedal signal P₂ to produce another pedal limit signal P_{LimR}. In particular, if the difference signal R_{Max}−R is positive, then the incrementing/decrementing function 64 adds the predetermined amount dP to the output accelerator pedal signal P₂ to produce the pedal limit signal P_{LimR}. On the other hand, if the difference signal R_{Max}−R is negative, then the incrementing/decrementing function 64 subtracts the predetermined amount dP from the output accelerator pedal signal P₂ to produce the pedal limit signal P_{LimR}. With each of the series of clock pulses CLK, the unit 30 also performs an incrementing/decrementing function 68 on a pedal limit signal P_{LimS} depending on the sign of the difference signal S_{Max}−S. If the difference signal is positive, then the incrementing/decrementing function 68 adds the predetermined amount dP to the pedal limit signal P_{LimS} provided that the pedal limit signal P_{LimS} is less than a preset maximum P_{Max} (for example 100%). On the other hand, if the difference signal S_{Max}−S is negative, then the incrementing/decrementing function 68 subtracts the predetermined amount dP from the pedal limit signal P_{LimS} provided that the pedal limit signal P_{LimS} is greater than a preset minimum P_{Min} (for example 0%). The minimising function 40 operates on the input accelerator pedal signal P₁ and the three pedal limit signals P_{LimA}, P_{LimR}, and P_{LimS} to produce the output accelerator pedal signal P₂ which is the least of those four signals P₁, P_{LimA}, P_{LimR}, and P_{LimS}.

It will therefore be appreciated that:
the output accelerator pedal signal P₂ will never exceed the input accelerator pedal signal P₁;
if and while: (a) the calculated road acceleration A exceeds the maximum road acceleration A_{Max} , or (b) the calculated engine speed R exceeds the predetermined maximum engine speed acceleration R_{Max}, then the output accelerator pedal signal P₂ will be ramped down at a rate of dP×F (for example 20% per second);
if and while the calculated road speed S exceeds the predetermined maximum road speed S_{Max}, the pedal limit signal P_{LimS} is ramped down at a rate of dP×F, and once the pedal limit signal P_{LimS} becomes less than the other three signals P₁, P_{LimA} and P_{LimR}, it begins to ramp down the output accelerator pedal signal P₂.
if and while: (a) the input accelerator pedal signal P₁ exceeds the output accelerator pedal signal P₂, (b) the calculated road acceleration A is less than the maximum road acceleration A_{Max}, (c) the calculated engine speed R is less than the predetermined maximum engine speed R_{Max}, and (d) the output accelerator pedal signal P₂ is not being limited by the limit signal P_{LimS}, then the output accelerator pedal signal P₂ will ramp up at a rate of dP×F (for example 20% per second).

In addition to modifying the accelerator pedal signal from P₁ to P₂, the fuel economy unit 30 of the second embodiment of FIGS. 5 and 6 also performs other functions in order to improve the fuel economy of the vehicle. As shown in FIG. 5, the unit 30 is also disposed in series with the signal connection from the stop/start switch 16 to the ECU 10, so that the fuel economy unit receives as an input the stop/start switch signal X from the stop/start switch and provides to the ECU 10 an output stop/start signal X′ which may differ from the input stop/start switch signal. The unit 30 is also connected to receive signals from the gear selector sensor 20, the clutch pedal sensor 22 (if the vehicle has a manual gearbox), the ambient temperature sensor 24 and the engine temperature sensor 26. The unit 30 normally passes the stop/start signal X without modification. However, in the event that all of the following criteria are met, the unit 30 is arranged to produce a stop/start signal X′ which commands the ECU 10 to stop the engine:
the road speed signal S has represented for a preset time that the vehicle is stationary, and
the engine speed signal R represents that the engine speed is below a preset threshold, and
the signal from the gear selector sensor 20 represents that the gearbox is in neutral, and
the signal from the engine temperature sensor 26 represents that the engine temperature is between two temperature thresholds, and
the signal from the ambient temperature sensor 24 represents that the ambient temperature is above a preset threshold.

Furthermore, in the event that any of the following criteria are met, the unit 30 is arranged to produce a stop/start signal X′ which commands the ECU 10 to restart the engine:
the signal from the stop/start switch represents that the driver wishes to start the engine, or
the signal from the clutch pedal sensor 22 represents that the driver has depressed the clutch, or
the road speed signal S represents that the vehicle has started to move, or
the accelerator pedal signal P₁ represents that the driver has depressed the accelerator pedal.

A stop/start over-ride switch 50 is provided in addition to the vehicle's conventional controls and is connected to the unit 30. The unit 30 is arranged to inhibit its stop/start functionality when the over-ride switch 50 is operated.

The fuel economy unit 30 may also be provided with other functionality. For example, a unit over-ride switch 52 may be provided in addition to the vehicle's conventional controls. When the unit over-ride switch 52 is operated, the unit 30 responds by directly passing the accelerator pedal input signal P₁ as the accelerator pedal output signal P₂. Also, a cruise-control switch 54 may be provided in addition to the vehicle's conventional controls. When the cruise-control switch 54 is operated, the unit 30 responds by storing the value of the current road speed signal S and then varying the output accelerator pedal signal P₂ as required so as to maintain the road speed of the vehicle at the stored value.

The fuel economy unit 30 may be implemented by a microcontroller and associated memory storing the operating program of the microcontroller, the maximum road and engine speed constants S_{Max}, R_{Max} and the maximum acceleration constant A_{Max} or the look-up table for the values of A_{Max} as a function of engine speed R. The unit 30 may be provided with a serial port 56 so that the program can be updated and the constants and look-up table can be changed. The unit 30 may be provided with a mobile telephone GSM messaging module 58 so that the constants and look-up table can be changed remotely. The unit 30 may also be arranged, in response to a particular command received by the messaging module 58, to disable the accelerator pedal output P₂ to the ECU 10 so that the vehicle can be remotely disabled for example in the event of theft. The unit 30 may also be provided with a GPS positioning module 60 so that the position of the vehicle can be reported via the messaging module 58. The unit 30 may also be provided with a status indicator 61 such as one or more LEDs which are arranged to indicate to the vehicle driver for example that the unit 30 is limiting the speed or acceleration of the vehicle or the speed of the engine.

Although the fuel economy devices 30 have been described above and shown in the drawings as being for use with a vehicle having an internal combustion engine, they may also be used with electric motor systems to modify a signal between a demand control of the electric motor system and a demand input of the system.

The fuel economy devices 30 described above can be fitted to a vehicle during manufacture, or retro-fitted after vehicle manufacture, without requiring any modification of the ECU 10. The fuel economy devices 30 may also be used with engines and motors which are not used to power vehicles.

It should be noted that the embodiments of the invention has been described above purely by way of example and that many other modifications and developments may be made thereto within the scope of the present invention.

1. A fuel economy unit for an engine system comprising an engine having a demand input, an output member drivable by the engine, and a user-operable demand control for providing a demand signal coupled to the engine demand input to control the engine output, the fuel economy unit comprising:
means for receiving an input signal indicative of acceleration of the output member or from which acceleration of the output member can be derived; and
means for modifying the coupling of the demand signal to the engine demand input in dependence upon the acceleration of the output member to limit the acceleration of the output member.

2. A fuel economy unit as claimed in claim 1, wherein:
the modifying means is operable to modify the demand signal to represent a lesser demand when the acceleration of the output member reaches an acceleration threshold value.

3. A fuel economy unit as claimed in claim 1, wherein:
the modifying means is operable to modify the demand signal to represent a progressively reducing demand while the acceleration of the output member exceeds an acceleration threshold value.

4. A fuel economy unit as claimed in claim 2, wherein:
the acceleration threshold value is preset.

5. A fuel economy unit as claimed in claim 1, wherein:
the input receiving means, or a further input receiving means, is arranged to receive an input signal indicative of the speed of the output member or from which speed of the output member can be derived.

6. A fuel economy unit as claimed in claim 5, wherein:
the modifying means is operable to modify the demand signal to represent a lesser demand when the acceleration of the output member reaches an acceleration threshold value and the acceleration threshold value is dependent on the speed of the output member.

7. A fuel economy unit as claimed in claim 5, further including:
means for deriving the acceleration of the output member by differentiation with respect to time of the speed of the output member.

8. A fuel economy unit as claimed in claim 3, wherein:
the modifying means is also operable to modify the coupling of the demand signal to the engine demand input in dependence upon the speed of the output member to limit the speed of the output member.

9. A fuel economy unit as claimed in claim 8, wherein:
the modifying means is operable to modify the demand signal to represent a lesser demand when the speed of the output member reaches an output speed threshold value.

10. A fuel economy unit as claimed in claim 1, wherein:
the fuel economy unit further includes further means for receiving a further input signal indicative of the speed of the engine or from which the speed of the engine can be derived.

11. A fuel economy unit as claimed in claim 10, wherein:
the modifying means is operable to modify the demand signal to represent a lesser demand when the acceleration of the output member reaches an acceleration threshold value and the acceleration threshold value is dependent on the speed of the engine.

12. A fuel economy unit as claimed in claim 10, wherein:
the modifying means is also operable to modify the coupling of the demand signal to the engine demand input in dependence upon the speed of the engine to limit the speed of the engine.

13. A fuel economy unit as claimed in claim 12, wherein:
the modifying means is operable to modify the demand signal to represent a lesser demand when the speed of the engine reaches an engine speed threshold value.

14. A fuel economy unit as claimed in claim 12, wherein:
the modifying means is operable to modify the demand signal to represent a progressively reducing demand while the speed of the engine exceeds an engine speed threshold value.

15. An engine system comprising:
an engine having a demand input;
an output member drivable by the engine;
a user-operable demand control for providing a demand signal coupled to the engine demand input to control the engine output; and
a fuel economy unit as claimed in any preceding claim for modifying the coupling of the demand signal to the engine demand input.

16. An engine system as claimed in claim 15, wherein:
the engine is or includes an internal combustion engine.

17. An engine system as claimed in claim 15, wherein:
the engine is or includes an electric motor.

18. An engine system as claimed in claim 15, wherein:
the engine includes an electronic ECU having an electrical demand input acting as the engine demand input; the user-operable demand control comprises a demand sensor for producing an electrical demand signal dependent on the position of the demand control, and a connection for connecting the demand signal to the demand input of the ECU; and the modifying means is operable to modify the demand signal between the demand sensor and the demand input of the ECU.

19. An engine system as claimed in claim 15, wherein:
the engine system includes a first sensor for producing an electrical signal indicative of acceleration of the output member or from which acceleration of the output member can be derived, the electrical signal being received by the signal receiving means of the fuel economy unit.

20. An engine system as claimed in claim 19, wherein:
the first sensor is arranged to produce an electrical signal indicative of speed of the output member or from which speed of the output member can be derived.

21. An engine system as claimed in claim 15, wherein:
the engine system includes a variable-ratio gearbox between the engine and the output member.

22. An engine system as claimed in claim 15, wherein:
the fuel economy unit further includes further means for receiving a further input signal indicative of the speed of the engine or from which the speed of the engine can be derived and the engine system includes a second sensor for producing a further electrical signal indicative the speed of the engine or from which the speed of the engine can be derived, the further electrical signal being received by the further signal receiving means of the fuel economy unit

23. A motor vehicle having an engine system as claimed in claim 15, wherein the speed of the output member is substantially proportional to the speed of the vehicle.
